(19) United States
(12) Patent Application Publication
(10) Pub. No.: US 2026/0122439 A1
(43) Pub. Date: Apr. 30, 2026

(54) FREQUENCY-DOMAIN IMPROVEMENT OF IN-ROOM AUDIO BASED ON TIME-DOMAIN METRICS

(71) Applicant: Biamp Systems, LLC, Beaverton, OR (US)

(72) Inventors: Charles Emory Hughes, II, Gastonia, NC (US); Xian Chloe Yu, Bryn Mawr, PA (US); Aaron Anthony Lutzo, Bridgeport, PA (US); Karl Ingram Nordstrom, Beaverton, OR (US)

(73) Assignee: Biamp Systems, LLC, Beaverton, OR (US)

(21) Appl. No.: 18/929,760

(22) Filed: Oct. 29, 2024

(51) Int. Cl. H04S 7/00

(52) U.S. Cl. CPC H04S 7/301

(57) ABSTRACT

An example operation may include controlling equalization of a loudspeaker within a location based on acoustic characteristics of the location and the loudspeaker, receiving audio measurements of the loudspeaker and location from at least one microphone that is also located in the location, calculating data for a time-domain metric of the location and loudspeaker in one or more fractional-octave frequency bands based on the audio measurements, and modifying at least one equalization setting of the loudspeaker based on relative values of the time-domain metric in the one or more fractional-octave frequency bands.

### BACKGROUND

The size and shape of a room, along with the wall construction and materials used for the surface finishes in the room, greatly affects the acoustical properties of the room and, hence, the listener's experience. Sound energy at different frequencies can build up in the room and decay differently. This can lead to less-than-ideal sound quality in the room due to different frequencies having different decay times. Typically, this is dealt with by taking measurements in the room, determining frequency response characteristics of the room, and then using equalization to optimize the frequency response characteristics. However, finding response characteristics in the frequency domain at different locations in the room can be difficult. What would be more appropriate is to find a global response characteristic (i.e., for the entire room) that is more applicable for equalization.

### SUMMARY

One example embodiment provides an apparatus that includes a memory which is communicably coupled to a processor, wherein the processor may control equalization applied to a loudspeaker within a location based on acoustic characteristics of the location and the loudspeaker, receive audio measurements of the loudspeaker and location from at least one microphone that is also located in the location, calculate data for a time-domain metric of the location and loudspeaker in one or more fractional-octave frequency bands based on the audio measurements, and modify at least one equalization setting of the loudspeaker based on relative values of the time-domain metric in the one or more fractional-octave frequency bands.

Another example embodiment provides a method that includes one or more of controlling equalization of a loudspeaker within a location based on acoustic characteristics of the location and the loudspeaker, receiving audio measurements of the loudspeaker and location from at least one microphone that is also located in the location, calculating data for a time-domain metric of the location and loudspeaker in one or more fractional-octave frequency bands based on the audio measurements, and modifying at least one equalization setting of the loudspeaker based on relative values of the time-domain metric in the one or more fractional-octave frequency bands.

A further example embodiment provides a computer readable storage medium comprising instructions, that when read by a processor, cause the processor to perform one or more of controlling equalization of a loudspeaker within a location based on acoustic characteristics of the location and the loudspeaker, receiving audio measurements of the loudspeaker and location from at least one microphone that is also located in the location, calculating data for a time-domain metric of the location and loudspeaker in one or more fractional-octave frequency bands based on the audio measurements, and modifying at least one equalization setting of the loudspeaker based on relative values of the time-domain metric in the one or more fractional-octave frequency bands.

### BRIEF DESCRIPTION OF THE DRAWINGS

FIG. 1A is a diagram illustrating a process of controlling the equalization of a loudspeaker system according to example embodiments.

FIG. 1B is a diagram illustrating a process of controlling a loudspeaker to produce an audio signal and at least one microphone to measure an RIR according to example embodiments.

FIG. 1C is a diagram illustrating a process of generating a frequency-dependent, time-domain metric based on the measured RIR according to example embodiments.

FIG. 1D is a diagram illustrating a process of modifying settings of frequency-based characteristics of the loudspeaker based on the time-domain metric according to example embodiments.

FIG. 2A is a diagram illustrating a method of improving the sound quality in a room based on frequency-dependent, time-domain metrics according to other example embodiments.

FIG. 2B is a diagram illustrating a method of improving the sound quality in a room based on frequency-dependent, time-domain metric according to other example embodiments.

FIG. 3 is a diagram illustrating a computing system that may be used in the examples herein according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a system that can improve the sound quality in a room by analyzing sound in the time-domain, rather than in the frequency domain (frequency response characteristics). As an example, the system may be used to adjust the sound quality of at least one loudspeaker. According to various embodiments, rather than analyze a frequency characteristic of the sound, the system can analyze how the energy in the room changes as a function of time, which can provide a better understanding of how to apply equalization for the entire room rather than specific locations within the room. The system can compare direct sound at a particular location to sound arriving later in time, such as reflections off of walls, etc. Late arriving sound from reflections in the room can exhibit an adverse influence on the sound quality within the room.

The example embodiments may rely on different time-domain metrics to help quantify the effects of a room on the sound quality within the room. Examples of the time-domain metrics include, but are not limited to, Definition (D), Reverb Time (T), Clarity (C), or the like. Furthermore, the time-domain metrics may be calculated using different split times, for example, 50 milliseconds, 80 milliseconds, 100 milliseconds, or the like. Furthermore, the time-domain metrics may be calculated for octave or fractional-octave bands such as ⅓, ⅙, 1/12, and the like.

When a loudspeaker is initially installed at a location (such as a room, etc.), the system may direct the loudspeaker to send out audio and measure the audio signal with microphones at one or more positions within the room. The measured audio can be provided to the system and used to calculate one or more time-domain metrics. As an example, the Definition of the audio having a 50 ms split time can be calculated for different octave bands, and the data may be plotted on a graph. Furthermore, the system may analyze the data and “tune” the loudspeaker by adjusting the EQ level of one or more frequency bands thereby improving the sound quality generated by the loudspeaker in the room. The process may be performed once, for example, during an initial installation, thereby improving the audio quality. If the room is subsequently changed (e.g., new furniture, renovations, etc.) the process may be repeated.

The system described herein may automatically derive magnitude adjustments in the frequency domain for equalization (EQ) filtering of an audio signal to improve the subjective sound quality of the in-room listening experience. The size and shape of a room, along with the wall construction and materials used for the surface finishes in the room, greatly affects the acoustical properties of the room and, hence, the listener's experience. Sound energy at different frequencies can build up in the room and decay differently. This can lead to less-than-ideal subjective sound quality in the room due to different frequencies having different decay times. When a loudspeaker radiates sound into a room, it is possible to modify (apply equalization filtering to) the signal produced by the loudspeaker to improve the sound quality perceived by listeners located in the room.

The system described in the example embodiments can capture measurements of sound in a room and determine at least one time-domain-based metric, for example, Definition for a 50 millisecond split time, also referred to as D50. The system can generate frequency-domain EQ (equalization) filtering to improve the subjective sound quality in the room based on the frequency-dependent data of the time-domain-based metric generated by the system. The D50 time-domain metric is dependent on the acoustical characteristics of the room, as well as the directivity control characteristics of the loudspeakers(s) being used in the room. It should also be appreciated that different split times may be used, for example, 20 milliseconds, 80 milliseconds, 100 milliseconds, 200 milliseconds, or the like. Also, it should be appreciated that different time-domain-based metrics may be used such as Clarity, Reverb Time, and the like.

According to various embodiments, the system described herein may be implemented by a software application hosted on a host computer such as a web server, a cloud platform, a desktop computer, a laptop, a mobile device, or the like. The system may measure a room impulse response (RIR) with at least one microphone (sensor) in the room excited by the loudspeaker system(s) that output the sound in the room. The system may remove ambient (background) noise from the RIR measurement(s). Furthermore, the system may calculate a time-domain metric (e.g., D50, etc.) in 1/N octave bands from the noise-reduced RIR measurement(s). Here, N can be any integer but typically has a value of 1, 3, 6, 12, or 24. The system may plot the frequency-dependent, time-domain metric data on a graph and use the shape of the graph, or otherwise analyze the data, to generate magnitude adjustments of one or more frequency bands (bandwidths) for EQ filtering. The EQ filtering may be applied, within a targeted frequency range, to an audio signal delivered to the loudspeaker. For example, the system may apply the generated EQ to an audio signal that is produced by the loudspeaker used in the room for which the RIR measurements were performed.

If the RIR measurements are made in non-ideal measurement locations (e.g. not where the listeners are intended to be), the system may apply offset adjustments to either the RIR data and/or the calculated time-domain metric as a means to “translate” the data from what it is to what it would be, or an estimate of what it would be, if the measurements had been made in a more desirable/appropriate location (e.g. where a listener would be located). It should be appreciated that although not expressly mentioned, additional steps may be performed by the process described herein to generate more improvement(s).

Using a time-domain (time-based) metric to derive a frequency-domain (frequency-based) modification to an audio signal reproduced by a loudspeaker is a new approach for improving the sound quality in a room. In other words, the system described herein uses time-domain measurements to inform the tuning of EQ filters to minimize the effects of acoustical problems in a room and improve the overall listener experience. In contrast, a system that measures frequency-domain anomalies at specific locations in the room can only capture problems that are present at those locations (local problems), such as room modes. Attempting to use EQ to mitigate local problems (like room-modes at one location) can result in more severe problems being created at other locations. The use of a time-domain metric can result in a more spatially global representation of the sound quality problems to be addressed with the use of EQ.

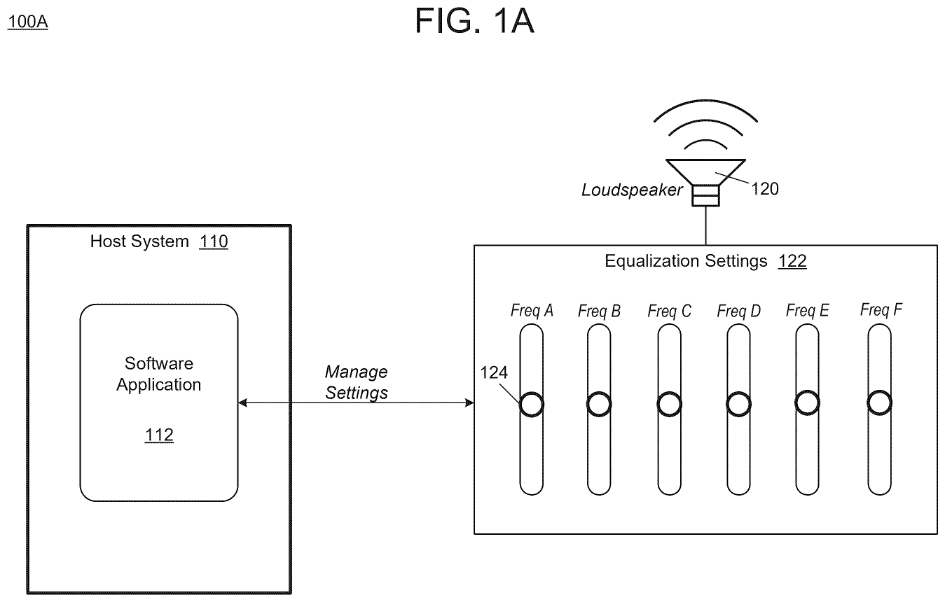

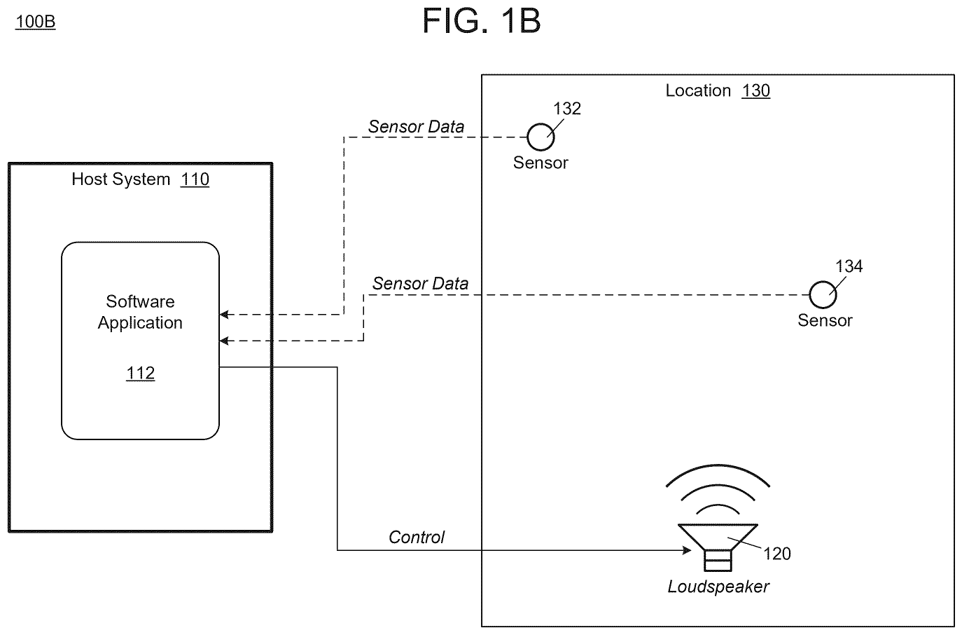

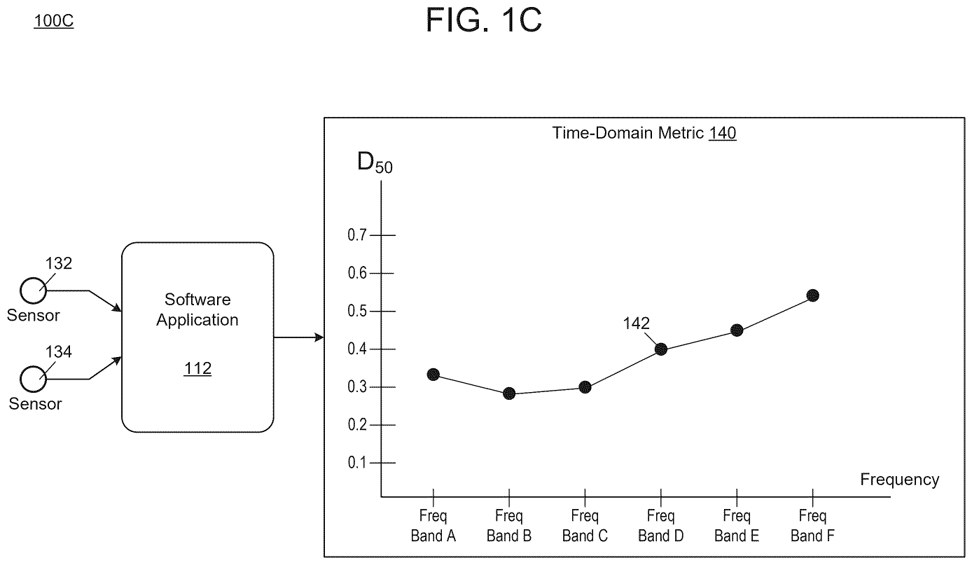

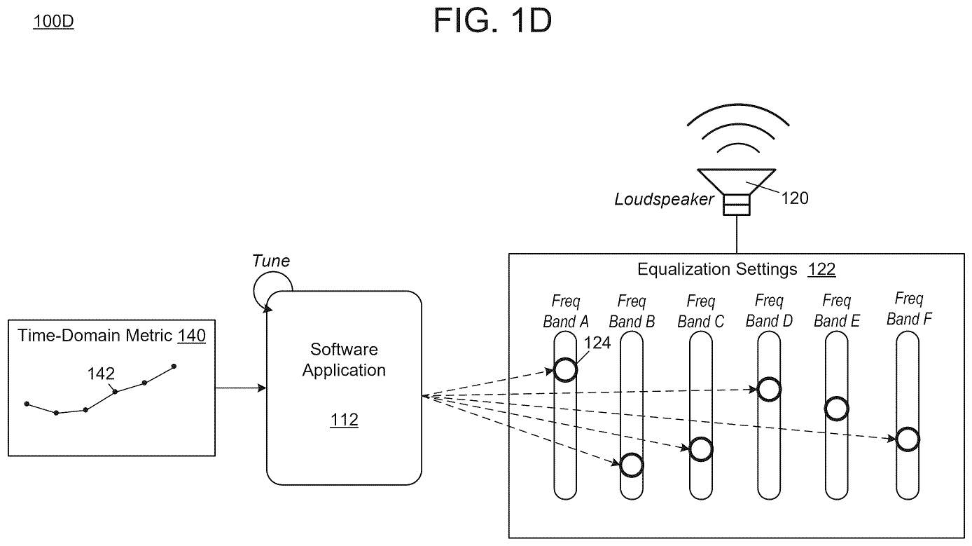

FIG. 1A illustrates a process 100A of controlling the equalization of a loudspeaker system according to example embodiments. Referring to FIG. 1A, a host system 110 may host a software application 112 that provides equalization (EQ) for audio output by a loudspeaker 120. In this example, the host system 110 may be a desktop computer, a laptop computer, a tablet, a web server, a cloud platform, or the like. In the case of a local computer such as a desktop, laptop, tablet, etc. the host platform 110 may be connected to the loudspeaker 120 through a cable, a wire, plug, or the like. In the case of the host platform 110 being a server, cloud platform, etc. the loudspeaker 120 may be connected to the host system 110 over a network such as the Internet, a private network, etc. Here, the loudspeaker 120 may also be directly coupled to a local computer via a cable. The local computer can transmit and receive communications with the host system 110 over the network.

In this example, the software application 112 may manage control settings 122 of the loudspeaker 120 from the loudspeaker 120. The control settings 122 refer to acoustic characteristics such as phase, magnitude, and the like, of various frequencies of sound output by the loudspeaker 120. In some embodiments, the control settings 122 may initially be set to default of zero changes, or some other settings that might optimize certain performance aspects of the loudspeaker 120.

FIG. 1B illustrates a process 100B of controlling the loudspeaker 120 to produce an audio signal and at least one microphone to capture the audio signal according to example embodiments. Referring to FIG. 1B, the loudspeaker 120 is disposed within a location 130. The location 130 may be a physical location such as a room, auditorium, office, school, or the like. The loudspeaker 120 may be placed anywhere in the location 130. In addition, the location 130 also includes a microphone 132 and a microphone 134 disposed at different places within the location 130. Here, the system has one loudspeaker and two microphones, however, the embodiments are not limited thereto. It should be appreciated that multiple loudspeakers may be tuned at the same time, and that at least one microphone may be used to capture audio signals output from the loudspeaker(s).

According to various embodiments, the software application 112 may send an audio signal such as a sound, etc. to the sound system for a period of time such as a few seconds, or more. In response, the loudspeaker 120 outputs sound/audio signal within the location 130. The audio signal output by the loudspeaker 120 may be captured by the microphone 132 and the microphone 134 and recorded. The audio signals may be fed back to the software application 112 for further analysis by the software application 112. As an example, the audio signal may be a random/pseudo-random noise, a multi-tone signal, a swept sine signal, speech, music, and the like.

FIG. 1C illustrates a process 100C of generating a graph 140 of the data for a time-domain metric based on the audio signal detected from the loudspeaker according to example embodiments. Referring to FIG. 1C, the software application may receive the audio signal(s) captured by the microphone 132 and the microphone 134 and generate one or more graphs of one or more time-domain metrics. In this example, the software application 112 generates the graph 140 of Definition (D) using a 50 millisecond split time (D50) for different fractional-octave bands. Although Definition (D) is used in this example, and a 50 millisecond split time are used, it should be appreciated that different time-domain metrics may be used such as Clarity, Reverb Time, or the like, and that different split intervals may be used such as 20 milliseconds, 80 milliseconds, 100 milliseconds, 200 milliseconds, or the like.

Here, the software application 112 may receive the audio signal(s) captured by the microphone 132 and the microphone 134, calculate the data for desired time-domain metric, and may generate the graph 140. As an example, a predefined algorithm may be applied to the audio signals to determine the time-domain metric(s). For example, definition 50 may be calculated by determining a ratio of early received sound (e.g., 0-50 ms, etc. after direct sound arrival) to the total received energy. The value of different frequency bands can be weighted differently.

FIG. 1D illustrates a process 100D of modifying settings of frequency-based characteristics of the loudspeaker 120 based on the time-domain metric according to example embodiments. Referring to FIG. 1D, the software application 112 may modify equalization (EQ) 122 applied to the loudspeaker 120 based on the data and/or graph 140 of the time-domain metric. For example, a shape of the graph 140 or the relative values of the time-domain metrics at different frequency bands (e.g., frequency band 142, etc.) may be used to modify an EQ setting 124 of at least one frequency band of the loudspeaker 120.

As a result, the loudspeaker 120 may be tuned or otherwise calibrated for the location 130 based on the time-domain metric.

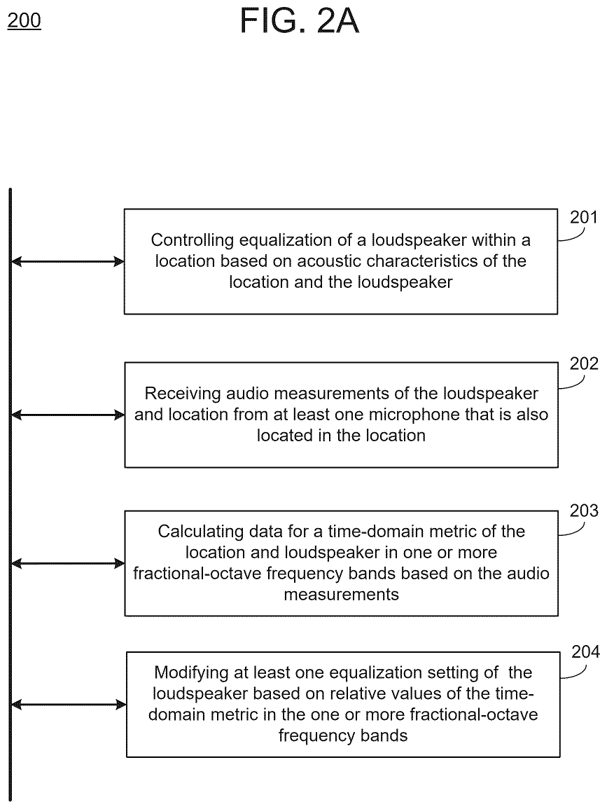

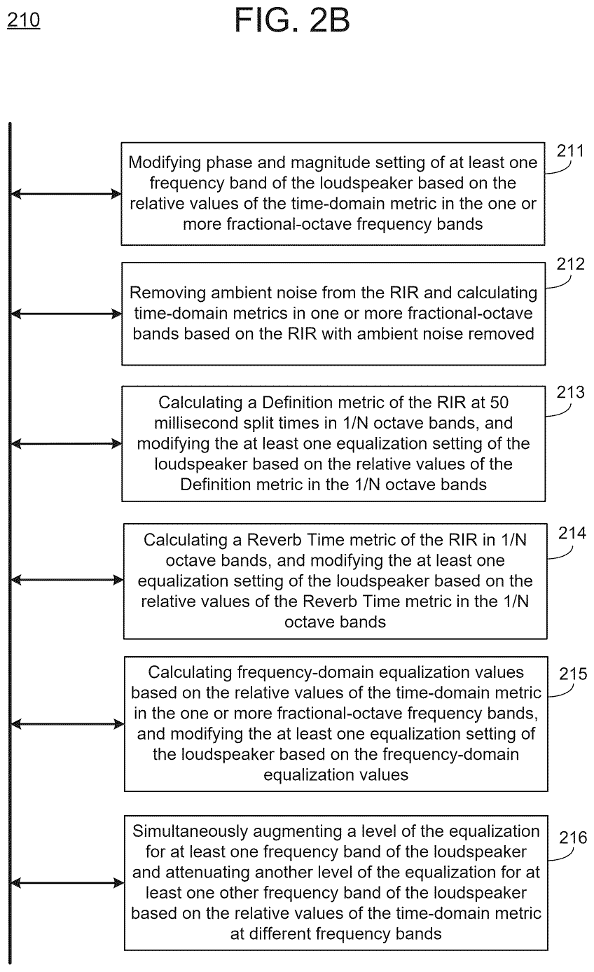

FIG. 2A illustrates a method 200 of improving the sound quality in a room by applying EQ in the frequency domain based on a time-domain metric according to other example embodiments. For example, the method 200 may be performed by a software application executed by at least one processor of a computing system such as a cloud platform, a web server, a user device, a combination of systems, and the like. Referring to FIG. 2A, in 201, the method may include applying equalization to a loudspeaker based on the acoustical properties of the room in which the loudspeaker in located and the interaction of the loudspeaker with the room. In 202, the method may include receiving audio measurements of the sound signal from at least one microphone that is also located in the location. In 203, the method may include generating a graph and/or analyzing the relative values of the time-domain metrics at different frequency bands based on the RIR measurements. In 204, the method may include applying EQ to the loudspeaker in at least one frequency band based on the relative values of the time-domain metrics at different frequency bands.

FIG. 2B illustrates a method 210 of improving the sound quality in a room by applying EQ in the frequency domain based on a time-domain metric according to other example embodiments. For example, the method 210 may be performed by a software application executed by at least one processor of a computing system such as a cloud platform, a web server, a user device, a combination of systems, and the like. Referring to FIG. 2B, in 211, the method may include applying EQ to modify the magnitude and phase of the frequency response of the loudspeaker based on the relative values of the time-domain metrics at different frequency bands. In 212, the audio measurements may include a room impulse response (RIR) measured by the at least microphone, and the method may further include removing ambient noise from the RIR and calculating the time-domain metric based on the RIR with ambient noise removed.

In 213, the method may include calculating Definition using a 50 millisecond split time in 1/N octave bands, where N comprises an integer value of at least one of 1, 3, 6, 12, and/or 24, and applying EQ in at least one frequency band based on the relative values of the time-domain metrics at different 1/N octave bands. In 214, the method may further include applying frequency-domain EQ based on the relative values of the time-domain metrics at different frequency bands.

In 215, the method may include calculating RT metrics in 1/N octave bands, where N comprises an integer value of at least one of 1, 3, 6, 12, and/or 24, and applying EQ in at least one frequency band based on the relative values of the RT metrics at different 1/N octave bands. In 216, the method may include simultaneously augmenting the level of the EQ for at least one frequency band and attenuating the level of the EQ for at least one other frequency band based on the relative values of the time-domain metrics at different frequency bands within the location.

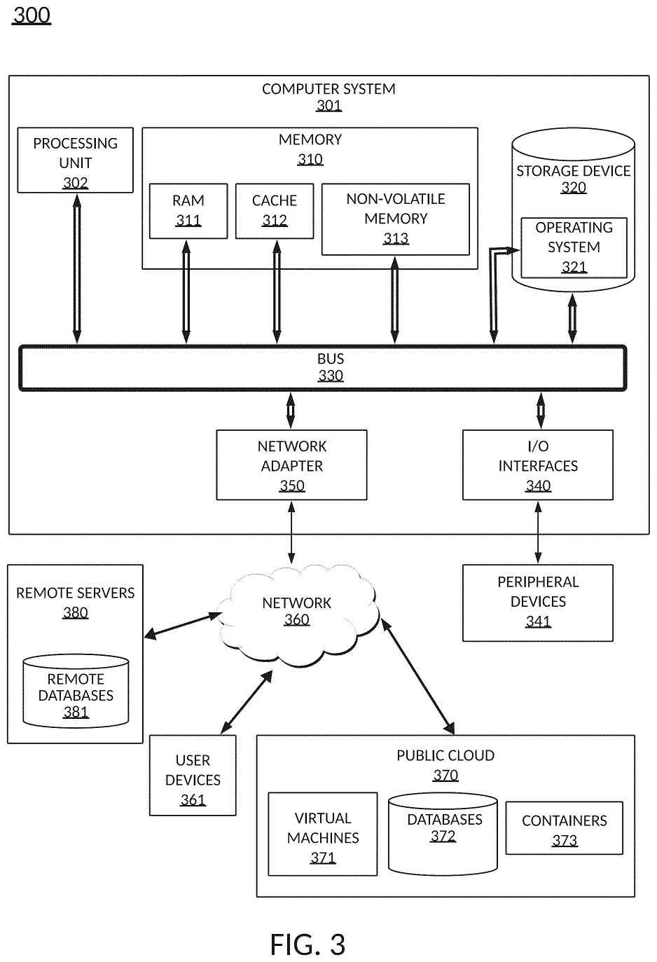

The examples and features of the instant solution may be implemented in one or more of the elements described or depicted herein, including for example, the elements described or depicted in FIG. 3. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 3 illustrates an example computer system architecture, which may represent or be integrated in any of the above-described components, etc.

FIG. 3 illustrates a computing environment according to the instant solution's example features, structures, or characteristics. FIG. 3 is not intended to suggest any limitation as to the scope of use or functionality of features, structures, or characteristics of the instant solution of the application described herein. Regardless, the computing environment 300 can be implemented to perform any of the functionalities described herein. In computing environment 300, there is a computer system 301, operational within numerous other general-purpose or special-purpose computing system environments or configurations.

Computer system 301 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 360 or querying a database. Depending upon the technology, the performance of a computer-implemented method may be distributed among multiple computers and among multiple locations. However, in this presentation of the computing environment 300, a detailed discussion is focused on a single computer, specifically computer system 301, to keep the presentation as simple as possible.

Computer system 301 may be located in a cloud, even though it is not shown in a cloud in FIG. 3. On the other hand, computer system 301 may not be in a cloud except to any extent as may be affirmatively indicated. Computer system 301 may be described in the general context of computer system-executable instructions, such as program modules, executed by a computer system 301. Generally, program modules may include routines, programs, objects, components, logic, data structures, and so on that perform tasks or implement certain abstract data types. As shown in FIG. 3, computer system 301 in computing environment 300 is shown in the form of a general-purpose computing device. The components of computer system 301 may include but are not limited to, at least one processor or processing unit 302, a system memory 310, and a bus 330 that couples various system components, including system memory 310 to processing unit 302.

Processing unit 302 includes at least one computer processor of any type now known or to be developed. The processing unit 302 may contain circuitry distributed over multiple integrated circuit chips. The processing unit 302 may also implement multiple processor threads and multiple processor cores. Cache 312 is a memory that may be in the processor chip package(s) or located “off-chip,” as depicted in FIG. 3. Cache 312 is typically used for data or code accessed by the threads or cores running on the processing unit 302. In some computing environments, processing unit 302 may be designed to work with qubits and perform quantum computing.

Memory 310 is any volatile memory now known or to be developed in the future. Examples include dynamic random-access memory (RAM) 311 or static type RAM 311. Typically, the volatile memory is characterized by random access, but this may not be the characterization unless affirmatively indicated. In computer system 301, memory 310 is in a single package. It is internal to computer system 301, but alternatively or additionally, the volatile memory may be distributed over multiple packages and/or located externally with respect to computer system 301. By way of example, memory 310 can be provided for reading from and writing to a non-removable, non-volatile magnetic media (shown as storage device 320, and typically called a “hard drive”). Memory 310 may include at least one program product having a set (e.g., at least one) of program modules configured to carry out the functions of various features, structures, or characteristics of the instant solution of the application. A typical computer system 301 may include cache 312, a specialized volatile memory generally faster than RAM 311 and generally located closer to the processing unit 302. Cache 312 stores frequently accessed data and instructions accessed by the processing unit 302 to speed up processing time. The computer system 301 may also include non-volatile memory 313 in the form of ROM, PROM, EEPROM, and flash memory. Non-volatile memory 313 often contains programming instructions for starting the computer, including the basic input/output system (BIOS) and information to start the operating system 321.

Computer system 301 may include a removable/non-removable, volatile/non-volatile computer storage device 320. For example, storage device 320 can be a non-removable, non-volatile magnetic media (not shown and typically called a “hard drive”). At least one data interface can connect it to the bus 330. In features, structures, or characteristics of the instant solution where computer system 301 has a large amount of storage (for example, where computer system 301 locally stores and manages a large database), then this storage may be provided by peripheral storage devices 320 designed for storing very large amounts of data, such as a storage area network (SAN) that is shared by multiple, geographically distributed computers.

The operating system 321 is software that manages computer system 301 hardware resources and provides common services for computer programs. Operating system 321 may take several forms, such as various known proprietary operating systems or open-source Portable Operating System Interface type operating systems that employ a kernel.

The bus 330 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 330 is the signal conduction path that allows the various components of computer system 301 to communicate.

Computer system 301 may communicate with at least one peripheral device, 341, via an input/output (I/O) interface, 340. Such devices may include a keyboard, a pointing device, a display, etc.; at least one device that enables a user to interact with computer system 301; and/or any devices (e.g., network card, modem, etc.) that enable computer system 301 to communicate with at least one other computing devices. Such communication can occur via I/O interface 340. As depicted, I/O interface 340 communicates with the other components of computer system 301 via bus 330.

Network adapter 350 enables the computer system 301 to connect and communicate with at least one network 360, such as a local area network (LAN), a wide area network (WAN), and/or a public network (e.g., the Internet). It bridges the computer's internal bus 330 and the external network, exchanging data efficiently and reliably. The network adapter 350 may include hardware, such as modems or Wi-Fi signal transceivers, and software for packetizing and/or de-packetizing data for communication network transmission. Network adapter 350 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 360 is any computer network that can receive and/or transmit data. Network 360 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 360 may be replaced and/or supplemented by LANs designed to communicate data between devices in a local area, such as a Wi-Fi network. The network 360 typically includes computer hardware such as copper transmission cables, optical transmission fibers, wireless transmission, routers, firewalls, switches, gateway computers, edge servers, and network infrastructure known now or to be developed in the future. Computer system 301 connects to network 360 via network adapter 350 and bus 330.

User devices 361 are any computer systems used and controlled by an end user in connection with computer system 301. For example, in a hypothetical case where computer system 301 is designed to provide a recommendation to an end user, this recommendation may typically be communicated from network adapter 350 of computer system 301 through network 360 to a user device 361, allowing user device 361 to display, or otherwise present, the recommendation to an end user. User devices can be a wide array, including personal computers, laptops, tablets, hand-held, mobile phones, etc.

A public cloud 370 is an on-demand availability of computer system resources, including data storage and computing power, without direct active management by the user. Public clouds 370 are often distributed, with data centers in multiple locations for availability and performance. Computing resources on public clouds 370 are shared across multiple tenants through virtual computing environments comprising virtual machines 371, databases 372, containers 373, and other resources. A container 373 is an isolated, lightweight software for running a software application on the host operating system 321. Containers 373 are built on top of the host operating system's kernel and contain software applications and some lightweight operating system APIs and services. In contrast, virtual machine 371 is a software layer with an operating system 321 and kernel. Virtual machines 371 are built on top of a hypervisor emulation layer designed to abstract a host computer's hardware from the operating software environment. Public clouds 370 generally offers databases 372, abstracting high-level database management activities. At least one element described or depicted in FIG. 3 can perform at least one of the actions, functionalities, or features described or depicted herein.

Remote servers 380 are any computers that serve at least some data and/or functionality over a network 360, for example, WAN, a virtual private network (VPN), a private cloud, or via the Internet to computer system 301. These networks 360 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 380 can also host remote databases 381, with the database located on one remote server 380 or distributed across multiple remote servers 380. Remote databases 381 are accessible from database client applications installed locally on the remote server 380, other remote servers 380, user devices 361, or computer system 301 across a network 360. An AI/ML model described or depicted here may reside fully or partially on any of the elements described or depicted in FIG. 3.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. An apparatus comprising:
a memory; and
a processor communicably coupled to the memory, the processor configured to:
control equalization applied to a loudspeaker within a location based on acoustic characteristics of the location and the loudspeaker;
receive audio measurements of the loudspeaker and location from at least one microphone that is also located in the location;
calculate data for a time-domain metric of the location and loudspeaker in one or more fractional-octave frequency bands based on the audio measurements; and
modify at least one equalization setting of the loudspeaker based on relative values of the time-domain metric in the one or more fractional-octave frequency bands.

2. The apparatus of claim 1, wherein the processor is configured to modify phase and magnitude setting of at least one frequency band of the loudspeaker based on the relative values of the time-domain metric in the one or more fractional-octave frequency bands.

3. The apparatus of claim 1, wherein the audio measurements comprise a room impulse response (RIR) measured by the at least one microphone, and the processor is configured to remove ambient noise from the RIR and calculating time-domain metrics in one or more fractional-octave frequency bands based on the RIR with ambient noise removed.

4. The apparatus of claim 3, wherein the processor is configured to calculate a Definition metric of the RIR using a split time in a range of 10 milliseconds to 250 milliseconds in 1/N octave bands, where N comprises an integer value of at least one of 1, 3, 6, 12, and 24, and modify the at least one equalization setting of the loudspeaker based on the relative values of the Definition metric in the 1/N octave bands.

5. The apparatus of claim 3, wherein the processor is configured to calculate a Definition metric of the RIR using a preferred 50 millisecond split times in 1/N octave bands, where N comprises an integer value of at least one of 1, 3, 6, 12, and 24, and modify the at least one equalization setting of the loudspeaker based on the relative values of the Definition metric in the 1/N octave bands.

6. The apparatus of claim 3, wherein the processor is configured to calculate a Reverb Time metric of the RIR in 1/N octave bands, where N comprises an integer value of at least one of 1, 3, 6, 12, and 24, and modify the at least one equalization setting of the loudspeaker based on the relative values of the Reverb Time metric in the 1/N octave bands.

7. The apparatus of claim 1, wherein the processor is further configured to calculate frequency-domain equalization values based on the relative values of the time-domain metric in the one or more fractional-octave frequency bands, and modify the at least one equalization setting of the loudspeaker based on the frequency-domain equalization values.

8. The apparatus of claim 1, wherein the processor is configured to augment a level of the equalization for at least one frequency band of the loudspeaker and attenuate another level of the equalization for at least one other frequency band of the loudspeaker based on the relative values of the time-domain metric at different frequency bands.

9. A method comprising:
controlling equalization of a loudspeaker within a location based on acoustic characteristics of the location and the loudspeaker;
receiving audio measurements of the loudspeaker and location from at least one microphone that is also located in the location;
calculating data for a time-domain metric of the location and loudspeaker in one or more fractional-octave frequency bands based on the audio measurements; and
modifying at least one equalization setting of the loudspeaker based on relative values of the time-domain metric in the one or more fractional-octave frequency bands.

10. The method of claim 9, wherein the modifying comprises modifying phase and magnitude setting of at least one frequency band of the loudspeaker based on the relative values of the time-domain metric in the one or more fractional-octave frequency bands.

11. The method of claim 9, wherein the audio measurements comprise a room impulse response (RIR) measured by the at least one microphone, and the method further comprises removing ambient noise from the RIR and calculating time-domain metrics in one or more fractional-octave bands based on the RIR with ambient noise removed.

12. The method of claim 11, wherein the calculating comprises calculating a Definition metric of the RIR using a split time in the range of 10 milliseconds to 250 milliseconds in 1/N octave bands, where N comprises an integer value of at least one of 1, 3, 6, 12, and 24, and modify the at least one equalization setting of the loudspeaker based on the relative values of the Definition metric in the 1/N octave bands.

13. The method of claim 11, wherein the calculating comprises calculating a Definition metric of the RIR using a preferred 50 millisecond split time in 1/N octave bands, where N comprises an integer value of at least one of 1, 3, 6, 12, and 24, and the modifying comprises modifying the at least one equalization setting of the loudspeaker based on the relative values of the Definition metric in the 1/N octave bands.

14. The method of claim 11, wherein the calculating comprises calculating a Reverb Time metric of the RIR in 1/N octave bands, where N comprises an integer value of at least one of 1, 3, 6, 12, and 24, and modifying the at least one equalization setting of the loudspeaker based on the relative values of the Reverb Time metric in the 1/N octave bands.

15. The method of claim 9, wherein the method further comprises calculating frequency-domain equalization values based on the relative values of the time-domain metric in the one or more fractional-octave frequency bands, and the modifying comprises modifying the at least one equalization setting of the loudspeaker based on the frequency-domain equalization values.

16. The method of claim 9, wherein the modifying comprises simultaneously augmenting a level of the equalization for at least one frequency band of the loudspeaker and attenuating another level of the equalization for at least one other frequency band of the loudspeaker based on the relative values of the time-domain metric at different frequency bands.

17. A computer-readable storage medium comprising instructions, that when read by a processor, cause the processor to perform:
controlling equalization applied to a loudspeaker within a location based on acoustic characteristics of the location and the loudspeaker;
receiving audio measurements of the loudspeaker and location from at least one microphone that is also located in the location;
calculating data for a time-domain metric of the location and loudspeaker in one or more fractional-octave frequency bands based on the audio measurements; and
modifying at least one equalization setting of the loudspeaker based on relative values of the time-domain metric in the one or more fractional-octave frequency bands.

18. The computer-readable storage medium of claim 17, wherein the modifying comprises modifying phase and magnitude setting of at least one frequency band of the loudspeaker based on the relative values of the time-domain metric in the one or more fractional-octave frequency bands.

19. The computer-readable storage medium of claim 17, wherein the audio measurements comprise a room impulse response (RIR) measured by the at least one microphone, and the processor is further configured to perform removing ambient noise from the RIR and calculating time-domain metrics in one or more fractional-octave frequency bands based on the RIR with ambient noise removed.

20. The computer-readable storage medium of claim 17, wherein the calculating comprises calculating a Definition metric of the RIR using a split time in the range of 10 milliseconds to 250 milliseconds in 1/N octave bands, where N comprises an integer value of at least one of 1, 3, 6, 12, and 24, and modify the at least one equalization setting of the loudspeaker based on the relative values of the Definition metric in the 1/N octave bands.
